(19) United States
(12) Patent Application Publication
(10) Pub. No.: US 2004/0139709 A1
(43) Pub. Date: Jul. 22, 2004

(54) Dynamic transfer chamber separator

(76) Inventors: Lewis Illingworth, Kensington, NH (US); David Reinfeld, Englewood, NJ (US)

Correspondence Address: WARD & OLIVO, Suite 300, 382 Springfield Avenue, Summit, NJ, 07901, US

(21) Appl. No.: 10/673,917

(22) Filed: Sep. 29, 2003

Related U.S. Application Data
(63) Continuation-in-part of application No. 10/318,320, filed on Dec. 12, 2002.
Application No. 10/318,320 is a continuation-in-part of application No. 10/025,376, filed on Dec. 19, 2001, now Pat. No. 6,719,830.
Application No. 10/025,376 is a continuation-in-part of application No. 09/835,084, filed on Apr. 13, 2001, now Pat. No. 6,687,951.
Application No. 09/835,084 is a continuation-in-part of application No. 09/829,416, filed on Apr. 9, 2001, now Pat. No. 6,729,839.
Application No. 09/829,416 is a continuation-in-part of application No. 09/728,602, filed on Dec. 1, 2000, now Pat. No. 6,616,094.
Application No. 09/728,602 is a continuation-in-part of application No. 09/316,318, filed on May 21, 1999, now Pat. No. 6,595,753.

(51) Int. Cl. B01D 45/14

(52) U.S. Cl. 55/406

(57) ABSTRACT

The present invention is a highly efficient separator. The invention utilizes centrifugal separation and a particulate reservoir having a fluid and particulate flow therein to achieve highly efficient, highly effective separation of, e.g., particulate matter from a fluid.

### CROSS REFERENCE TO OTHER APPLICATIONS

This application is filed as a continuation-in-part of co-pending application Ser. No. 10/318,320 entitled “Axial Flow Centrifugal Dust Separator,” filed Dec. 12, 2002, which is a continuation-in-part of co-pending Ser. No. 10/025,376 entitled “Toroidal Vortex Vacuum Cleaner Centrifugal Dust Separator,” filed Dec. 19, 2001, all of which are herein incorporated by reference.

### TECHNICAL FIELD OF THE INVENTION

The present invention relates generally to an improved separator. More specifically, the present invention relates to an improved separator that circulates dust around the inside wall of a cylindrical separation chamber in much the same way as a cyclonic or swirl tube separator. Unlike these two systems, which allow matter to fall to the bottom of the chamber, the present invention has a slot in the separation chamber wall. This allows matter to be carried out radially through the slot into a detritus collecting box. This transfer slot is shaped in such a way that tangential velocity in the matter swirling around the separation chamber wall is maintained as matter moves into the detritus box, and this motion is maintained in the detritus box in a manner that prevents it from returning to the separation chamber.

### BACKGROUND OF THE INVENTION

The inventors are aware of certain existing technology that if understood by the reader, would facilitate understanding of the novel subject matter of the present invention.

FIGS. 1A and 1B (PRIOR ART) depict a separator described in the inventors' application Ser. No. 10/025,376, which serves as the foundation for the novel subject matter herein. Referring to FIG. 1A, at the bottom of the separator are two concentric tubes, the inner tube 1 and the outer tube 2, through which fluid may pass. The annular duct created between inner tube 1 and outer tube 2 contains straightening vanes 11. Straightening vanes 11 extend radially outward from the outer wall of inner tube 1 to the inner wall of outer tube 2. Straightening vanes 11 also extend downward from the top of the exit duct created by the inner tube 1 and outer tube 2. The top of the inner tube 1 curves outward such that its vertical cross section, as shown in FIG. 1B, forms semicircles arranged with the open side of the circle facing downward. Centered directly above the inner tube 1 is the impeller 9. At the outside of the impeller are the impeller blades 8, which are fitted to conform to the curvature in the inner tube 1. The motor 10 which provides power to the impeller 9 is located above the impeller 9. Housing is provided containing the impeller blades, separation chamber, and dust collector. The dust housing connects to the concentric tubing providing in and out flow. The horizontal cross section of FIG. 1B illustrates the circular shape of the housing. The cylindrical walls of the housing maintain the vortex airflow. Attached to the cylindrical housing is the dust collector 5. The dust collector 5 is a sealed container in which debris ejected from the vortex accumulates. The housing has an opening in its outer wall through which dust may pass. As shown in the horizontal cross section FIG. 1B, the edge of the opening facing into the direction of airflow bends slightly inwards to facilitate dust collection. The dust collector 5 is attached to the outer and lower walls of the housing as shown in FIG. 1B. The walls of the outer tube 2 bend slightly outward to facilitate smooth airflow from the chamber 7 to the annular exit duct between inner tube 1 and outer tube 2. Nevertheless, other arrangements to facilitate airflow may be used as well. The inner tube 1 and outer tube 2 may extend downward and terminate with a toroidal vortex nozzle. However, the centrifugal dust separator is capable of functioning without such a nozzle. Any other concentric nozzle design may be used. In addition, any system that supplies an input flow to inner tube 1 and receives an output flow from annular duct formed between inner tube 1 and outer tube 2 is capable of utilizing the separator.

The flow geometry of the separator is also depicted in FIG. 1. This embodiment involves particulate-laden air being sucked up through the inner tube 1 under the power of the impeller 9. The impeller blades 8 then move the air in a circular pattern. The rotating air is then directed outward where it spirals downward along the outer wall of the chamber 7 creating a cylindrical vortex flow pattern. The kinetic energy of the circulating air creates a higher pressure than that of the air within the chamber 7. This higher pressure is maintained in the dust collector. Depending on the system geometry, this pressure may be higher or lower than ambient. This high pressure forces air inward thereby maintaining the air's circular path. However, the circulating particulates are not inhibited from carrying straight into the dust collector as shown in FIG. 1B. When the spiraling air reaches the bottom of the outer wall of the chamber 7, the air then spirals upward along the inner wall of the chamber 7. Remaining particulates may still travel outward from the inner spiral of air. The result is substantially clean air exiting the chamber 5 at the top of its inner wall. The cleaned air then flows downward into the annular duct created between the inner tube 1 and the outer tube 2. With the addition of straightening vanes 11, straight flowing air is supplied as a product to a toroidal vortex nozzle, for example. However, alternative embodiments are possible which do not involve a toroidal vortex nozzle or any nozzle.

An example of a toroidal vortex nozzle 1300 is depicted in FIG. 1C. The inner tube 1301 is thickened out and rounded off at the bottom (inner fairing 1306) for smooth airflow around from the air delivery duct 1302 to the air return duct 1303. The outer tube 1304 is extended a little way below the inner tube 1301 end and rounded inwards somewhat so that air from the delivery duct 1302 is not ejected directly downwards but tends towards the center. This minimizes the amount of air leaking sideways from the main flow. The nozzle has flow straightening vanes 1305 to eliminate any corkscrewing in the downward air motion in the air delivery duct 1302 that would throw air out sideways from the bottom of the outer tube 1304 due to centrifugal action.

The preceding technology is the basis for the novel subject of the present invention, and has been presented to assist the reader's understanding thereof.

### SUMMARY OF THE INVENTION

Although the terms “dust,” “dusty,” “air,” “dusty air,” and the like are used occasionally throughout to represent the fluid and particulate with which the invention operates, they should be taken as merely examples of a fluid and associated particulate. The invention is equally adept at separating, e.g., sand from water, and leaves from air. Also, the invention is not limited to separating matter of different states (e.g., a solid from a liquid), but could also separate matter of the same state (e.g., two insoluble liquids of different densities).

The performance of the inventors' prior systems can be improved by optimizing the design of the constituent parts without diverging drastically from their basic functions. Particularly, there are two crucial areas of change between the inventors' prior designs and the present invention. The first change is in the shape of the separation chamber and centrifugal impeller, and the second change is the shape of the transfer slot, which is the pathway to the dust box.

The separation chamber performance is improved by allowing dust to fly radially out of a centrifugal impeller without directing its path around a curved molding. Dust is ejected radially, and it circulates around the curved separation chamber wall. This provides a more direct route for dust into the dust box. Air having suspended particulates exits the impeller with both a radial and tangential velocity. When the air-particulate mixture hits the separation chamber wall in the vicinity of the transfer slot, it retains its tangential velocity but loses its radial velocity. This sudden direction change results in a large acceleration (and thus, a large force) being applied to the dust particles. Thus, the dust particles become concentrated in a thin layer around the separation chamber wall. The retained tangential velocity carries the particles through the transfer slot. Notably, the separators of the present invention will operate in an either vertical or horizontal orientation.

A transfer slot is inserted into the open space between the separation chamber and dust box. The transfer slot is shaped so that dust within the dust box circulates and the inertia of the moving dust prevents it from re-entering the separation chamber.

The use of two chambers that both have circulating air and dust in conjunction with a slot that allows “one way only” transfer of dust from one to the other is unique in the dust separation field. The performance of the present invention is superior to conventional cyclonic and swirl tube separators and several of the inventors' prior designs.

Thus, it is an object of the present invention to provide an efficient separator.

This and many other objects not listed will become readily apparent to one skilled in the art upon review of the following description, figures, and claims.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIGS. 1A, 1B, and 1C (PRIOR ART), already discussed, depict a prior art separator and toroidal vortex nozzle of the inventors' design;

FIGS. 2A and 2B depict a Dynamic Transfer Dust Separator arranged for concentric input and output; and

FIGS. 3A and 3B depict Dynamic Transfer Dust Separator arranged for in-line input and output.

### DETAILED DESCRIPTION OF THE PREFERRED EMBODIMENTS

As required, a detailed illustrative embodiment of the present invention is disclosed herein. However, techniques, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred embodiment (as well as some alternative embodiments) of the present invention and features thereof.

Again, though “dusty air” is used occasionally throughout this description, it is not the only medium in which the invention can operate. The invention functions equally well at separating, e.g., leaves, sticks, pebbles, sand, fluids, etc., from various types of fluids.

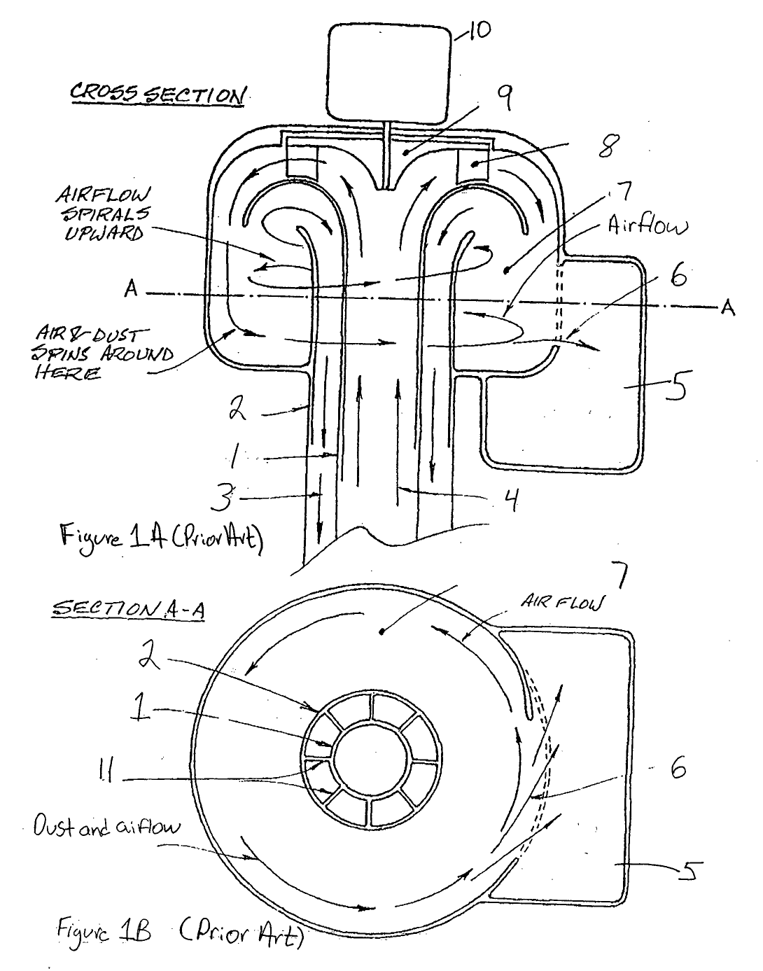

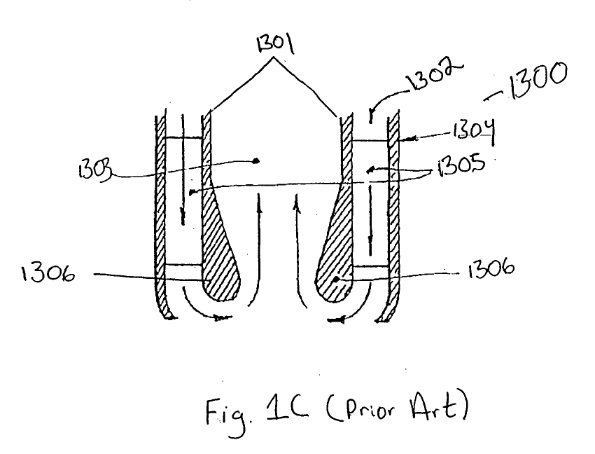

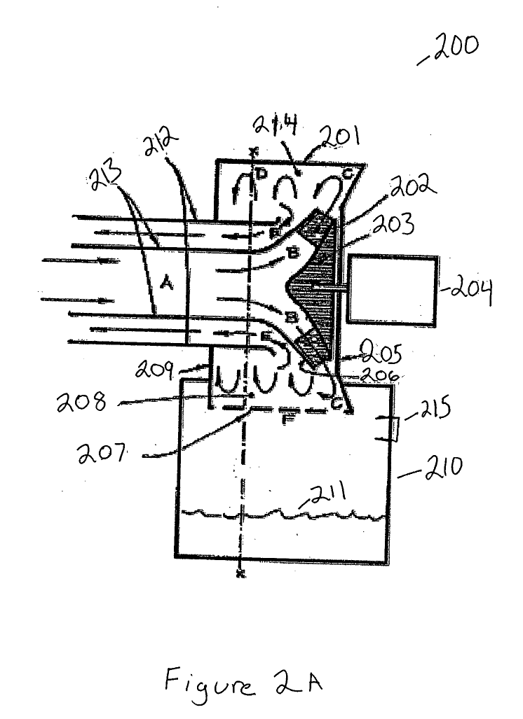

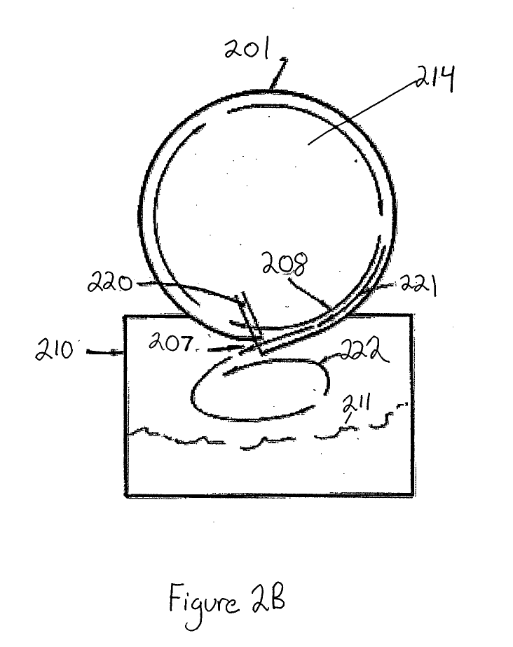

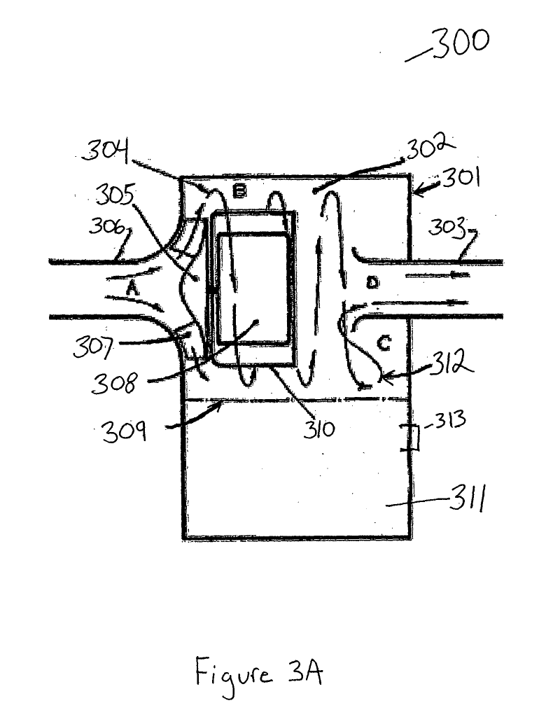

FIG. 2A shows the Dynamic Transfer Dust Separator 200 arranged for concentric dusty air input/clean air output operation. Dusty air enters through an inner tube 213 at A. It then passes at point B through the blades 202 of a centrifugal air pump consisting of impeller 203 and motor 204. This impeller 203 may take the conventional form, as in FIGS. 1A and 1B or it may be as shown herein with a sloping form that deflects the air by less than 90 degrees. The back plate 205 follows the form of the impeller 203 and air flows outward from B to C toward the outer casing 201. The inner tube 213 is flared out to form a venturi 206 with the impeller 203 for efficient operation. If used in combination with a toroidal vortex nozzle (see, for example, FIG. 1C), the effectiveness of the device can be enhanced by the addition of flow straightening vanes as shown in, e.g., FIGS. 1A, 1B, and 1C.

In previous systems, e.g., of FIGS. 1A, 1B and 1C, the air is deflected around and downwards by a molded form. In the present invention, there is no need for molded form because the air finds its own route at point C. The air turns from an outward flow into a spiraling flow 208 around the inside of the outer casing 201 at point D, toward the end plate 209. While air turns to find its own path, dust (due to its inertia) tends to proceed straight and to the inside of the outer casing 201, at point C. At that point, it either enters the transfer slot 207 at point F and goes on into the dust box 210, or it circles around in the outside of the spiraling airflow 208 at point D until it makes it through the transfer slot 207. Dust 211 eventually settles and accumulates in the dust box 210. Though the dust box 210 is shown generically in the drawings, it may take several forms. For example, it can be rigid, flexible, reusable, or disposable. One example of a dust box 210 would be a conventional or specially adapted disposable garbage bag. Unlike prior designs, the dust box 210 does not act as a vacuum bag, i.e., it does not perform a filtering function. Thus, the dust box 210 need not be porous.

Furthermore, the dust box 210 may be removable by decoupling, e.g., at the transfer slot 206. Of course, the dust box 210 could be configured to decouple at any convenient point as long as the required fluid flow is not affected. Alternatively, or in addition, the dust box 210 can comprise an emptying means 215 which can take the form of a door, plug, window, slot, or the like. The emptying means 215 allows a user to empty the contents of the dust box 210.

In earlier systems, e.g., FIGS. 1A, 1B and 1C, the molded corner following the centrifugal impeller turns both the dust and the air around so that the outward dust motion is lost before it reaches the transfer slot. The present invention is effective in throwing out heavier dirt and objects right at the beginning of the dust separation process at point C and leaves most of the length of the separation chamber 214 for finer dust particles to migrate to the casing wall, e.g., at D, and pass through the transfer slot 207. Also, by turning the air and dust flow between points A and C by less than 90 degrees, the wear and abrasion caused to the impeller 203 and its blades 202 by larger objects is reduced.

By the time the spiraling air 208 meets the end plate 209, it has shed the dust it contains due to centrifugal separation. The air thereafter moves inward to exit at point E and flows outward in the annular duct between the inner tube 213 and outer tube 212. The inner and outer tubes may terminate with, e.g., a toroidal vortex nozzle, an example of which is illustrated in FIG. 1C.

Of particular note, (1) the centrifugal impeller may turn the incoming dusty airflow by less than 90 degrees; and (2) there is no molded form to turn the dusty air around to spiral along the separation chamber—the air finds its own path, but the dust is thrown directly outwards to the outer casing wall and transfer slot.

FIG. 2B shows a cross-section X-X through the outer casing 201 of the separation chamber 214 and dust box 210. This is similar to FIG. 1B but differs in the shape of the transfer slot 207 and the provision for dust flow 222 within the dust box 210. The goal is to minimize the possibility of any dust 211 in the dust box 210 re-entering the separation chamber 214. The transfer slot 207 is changed from the open space of FIG. 1B (see index number 6) and features an overlap 220. This slot 207 is made wide enough across to allow the largest pieces of dirt and detritus to pass through. Dust flowing 221 around the inside surface of the outer casing 201 flows through the transfer slot 207 because its inertia prevents it from moving across the gap to remain in the air stream. The airflow 208 turns across the gap 207 and remains in the separation chamber 214. Dust passing into the dust box 210 keeps moving due to its inertia and a circulating dust flow 222 forms beneath the transfer slot 207. This circulation is maintained by airflow inside the dust box 210. Air circulating in the separation chamber 214 couples energy to the air circulating in the dust box 210 by friction as it passes across the transfer slot 207. Dust flow 222 inside the dust box 210 passes the end of the transfer slot 207, but its inertia prevents it from reversing direction to get back through the slot 207 into the separation chamber 214. If the dust 211 inside the dust box was stagnant, however, some could get sucked back into the separation chamber 214.

Thus, the opening between the separation chamber 214 and the dust box 210 is formed into a transfer slot 207 and the inertia of the dust flow 222 within the dust box 210 across the transfer slot 207 prevents dust 211 in the box from migrating back into the separation chamber 214.

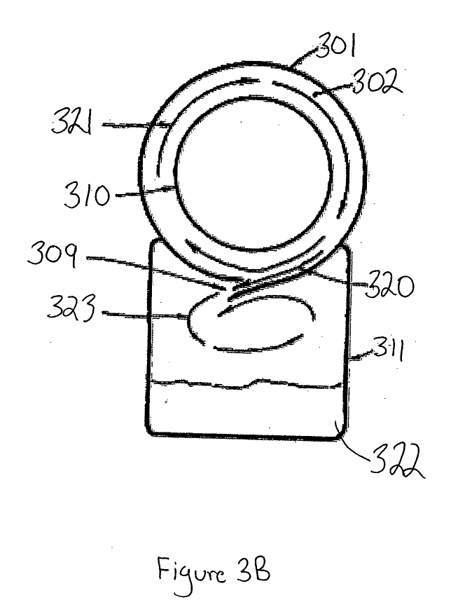

The invention has been described with reference to dust separators operating within a coaxial air system. However, the invention is not limited thereto. For example, the invention is also suited to in-line operation, both for vacuum cleaners and also for general air and fluid particle separators. An embodiment of such an in-line system is shown in FIGS. 3A and 3B.

Looking at the side view of separator 300 in FIG. 3A, dirty air is drawn in the input pipe 306 and it passes point A, moves through the blades 307 of a centrifugal pump comprising impeller 305 coupled to motor 308. Air (represented at this point by the streamline at point 304) leaving the blades 307 at point B moves from left to right while following a spiral path around circular inner air guide 310 until it reaches point C. There, the air moves inward in substantial accordance with the streamline at point 312 to enter the exit pipe 303 at point D. Centrifugal forces acting on dust particles in the air spiraling between the outer casing 301 and the circular inner air guide 310 cause the dust particles (or other particles, e.g., leaves, twigs, etc.) to migrate out to the inner wall of the outer casing 301. The space enclosed by the outer casing 301 thus comprises a separation chamber 302 with high dust concentration close to the outer walls of outer casing 301 and low dust concentration at the center, e.g., the center of the circle defining the circumference of output pipe 303. When air turns away from the outer wall at point C, the dust it contains continues to circulate around the inside of the outer wall of the separation chamber 302. The air at the center of the chamber 302 exits at point D substantially cleaned of dust. However, due to the inertia of the particulate matter, it cannot make the turn at point C. Instead, centrifugal force compels the particulates to eventually pass through the transfer slot 309 and settle at the bottom of the dust box 311. This is discussed in greater detail with respect to FIG. 3B.

Though the dust box 311 is shown generically in the drawings, it may take several forms. For example, it can be rigid, flexible, reusable, or disposable. One example of a dust box 311 would be a conventional or specially adapted disposable garbage bag. Unlike prior designs, the dust box 311 does not act as a vacuum bag, i.e., it does not perform a filtering function. Thus, the dust box 311 need not be porous.

Furthermore, the dust box 311 may be removable by decoupling, e.g., at the transfer slot 309. Of course, the dust box 311 could be configured to decouple at any convenient point as long as the required fluid flow is not affected. Alternatively, or in addition, the dust box 311 can comprise an emptying means 313 which can take the form of a door, plug, window, slot, or the like. The emptying means 313 allows a user to empty the contents of the dust box 311.

FIG. 3B shows a cross-section of the dust separator 300. This shows air 321 circulating within the separation chamber 302 between the central air guide 310 and the outer casing 301. Dust migrates to the outside of this circulating airflow 321, toward the inner wall of the outer casing 301. The transfer slot 309 in the bottom of this wall allows particulates (e.g., dust, leaves, twigs, etc.) to travel directly into the lower dust box 311 while air is able to turn and remain in the separation chamber, thereby continuing to circulate. The path of the particulate matter is illustrated generally by the streamline at points 320 and 323.

The system also works when the dust box 311 is to the side of the separation chamber 302. The circulating dusty airflow (see streamline at point 323) in the dust box 311 pushes the dust away from the transfer slot 309 to form coagulated dust masses 322.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

We claim:

1. A centrifugal separation system comprising:
fluid delivery means powered by a motor for providing a cylindrical vortex fluid flow;
a separation chamber for containing said fluid flow; and
a collector for collecting matter, coupled to said separation chamber by a transfer slot;
wherein said fluid flow centrifugally ejects said matter therefrom into said separation chamber, and further wherein said transfer slot effects circulation of said matter and said fluid flow within said collector.

2. A centrifugal separation system according to claim 1 wherein said fluid delivery means is powered by an electrical motor.

3. A centrifugal separation system according to claim 1 wherein said fluid delivery means is powered by a combustion motor.

4. A centrifugal separation system according to claim 1 wherein said motor is powered by compressed gas.

5. A centrifugal separation system according to claim 1 wherein said fluid delivery means is powered by a motor that is powered by a flowing fluid.

6. A centrifugal separation system according to claim 1 wherein said separation chamber is cylindrical.

7. A centrifugal separation system according to claim 1 wherein said fluid delivery means comprises an impeller assembly.

8. A centrifugal separation system according to claim 1 wherein said fluid delivery means comprises a centrifugal pump.

9. A centrifugal separation system according to claim 1, wherein said collector and said separation chamber are configured such that a pressure is developed in said collector that is greater than the pressure in said separation chamber.

10. A centrifugal separation system according to claim 1, wherein said matter is selected from the group consisting of dust, leaves, twigs, pebbles, nails, screws, nuts, dirt, and sand.

11. A centrifugal separation system according to claim 1 further comprising an inner tube and an outer tube, said inner tube and said outer tube being coaxial and coupled to said separation chamber, wherein the gap between said inner tube and said outer tube forms an annular duct.

12. A centrifugal separation system according to claim 1 wherein said collector is made of a flexible material.

13. A centrifugal separation system according to claim 1 wherein said collector is disposable.

14. A centrifugal separation system according to claim 1 wherein said collector is a garbage bag.

15. A centrifugal separation system according to claim 1 wherein said collector is removable.

16. A centrifugal separation system according to claim 1 wherein said circulation within said collector substantially prevents said matter from escaping said collector.

17. A centrifugal separation system comprising:
fluid delivery means for providing a fluid flow;
a separation chamber for separating matter from said fluid flow;
a collector for collecting said separated matter, coupled to said separation chamber by a transfer slot;
an inner tube and an outer tube, said inner tube and said outer tube forming an annular duct, said annular duct ending in a toroidal vortex nozzle.

18. A centrifugal separation system according to claim 17 wherein said fluid delivery means comprises flow straightening vanes.

19. A centrifugal separation system according to claim 17 wherein said transfer slot effects circulation of said matter and said fluid within said collector.

20. A centrifugal separation system according to claim 17 wherein said collector is removable.

21. A centrifugal separation system according to claim 17 wherein said collector further comprises means for emptying the contents of said collector.

22. A centrifugal separation system according to claim 17 wherein said collector further comprises a door.

23. A centrifugal separation system according to claim 17 wherein said collector further comprises a removable stopper.

24. A centrifugal separation system according to claim 17 wherein said fluid delivery means comprise a centrifugal pump.

25. A centrifugal separation system according to claim 17 wherein said collector is made of a flexible material.

26. A centrifugal separation system according to claim 17 wherein said collector is disposable.

27. A centrifugal separation system according to claim 17 wherein said collector is a garbage bag.

28. A centrifugal separation system according to claim 17 wherein said collector is removable.

29. A centrifugal separation system according to claim 17 wherein said circulation within said collector substantially prevents said matter from escaping said collector.

30. A centrifugal separation system comprising:
fluid delivery means for providing a fluid flow;
a separation chamber for separating from said fluid flow;
a collector for collecting said matter;
an opening in the wall of said separation chamber, said opening leading into said collector, said opening effecting fluid flow and matter flow within said collector;
an outer tube coupled to said separation chamber; and
an inner tube located inside said outer tube, said inner tube and said outer tube being coaxial, wherein the gap between said inner tube and said outer tube forms an annular duct.

31. A centrifugal separation system according to claim 30 wherein said fluid delivery means is powered by a motor.

32. A centrifugal separation system according to claim 30 wherein said fluid delivery means is powered by an electrical motor.

33. A centrifugal separation system according to claim 30 wherein said fluid delivery means is powered by a combustion motor.

34. A centrifugal separation system according to claim 30 wherein said fluid delivery means is powered by a motor that is powered by a compressed gas.

35. A centrifugal separation system according to claim 30 wherein said fluid delivery means is powered by a motor that is powered by a flowing fluid.

36. A centrifugal separation system according to claim 30 wherein said separation chamber is cylindrical.

37. A centrifugal separation system according to claim 30 wherein said fluid delivery means comprises an impeller assembly.

38. A centrifugal separation system according to claim 30 wherein said fluid delivery means comprises a centrifugal pump.

39. A centrifugal separation system according to claim 30, wherein said collector and said separation chamber are configured such that a pressure is developed in said collector that is greater than the pressure in said separation chamber.

40. A centrifugal separation system according to claim 30, wherein said matter is selected from the group consisting of dust, leaves, twigs, pebbles, nails, screws, nuts, dirt, and sand.

41. A centrifugal separation system according to claim 30 wherein said collector is made of a flexible material.

42. A centrifugal separation system according to claim 30 wherein said collector is disposable.

43. A centrifugal separation system according to claim 30 wherein said collector is a garbage bag.

44. A centrifugal separation system according to claim 30 wherein said collector is removable.

45. A centrifugal separation system according to claim 30 wherein said matter flow and said fluid flow within said collector substantially prevents said matter from escaping said collector.

46. A centrifugal separation system according to claim 30 wherein said inner and outer tubes end in a toroidal vortex nozzle.

47. A centrifugal separation system according to claim 30 further comprising flow straightening vanes disposed in said annular duct.

48. A centrifugal separation system according to claim 30 wherein said collector is removable.

49. A centrifugal separation system according to claim 30 further comprising means for emptying the contents of said collector.

50. A centrifugal separation system according to claim 30 wherein said collector further comprises a door for emptying the contents of said collector.

51. A centrifugal separation system according to claim 30 wherein said collector further comprises a removable stopper.

52. A method of centrifugally separating matter from a fluid comprising the steps of:
utilizing a motor to provide a cylindrical vortex fluid flow within a separation chamber;
centrifugally ejecting said matter into a collector; and
maintaining a fluid flow and matter flow within said collector, wherein said fluid flow and said matter flow within said collector substantially prevent the escape of said matter from said collector into said separation chamber.

53. A method according to claim 52 wherein said fluid flow is delivered to said separation chamber via an inner tube coupled thereto.

54. A method according to claim 52 wherein said fluid flow exits said separation chamber via an annular duct created between an inner tube and an outer tube, wherein said inner tube delivers said fluid flow to said separation chamber, and wherein said inner tube and said outer tube are coaxial.

55. A method according to claim 52 further comprising the step of creating a higher pressure in said collector than in said separation chamber such that said cylindrical vortex fluid flow is maintained without impeding said matter from carrying into said collector.

56. A method according to claim 52, wherein a toroidal vortex nozzle is located at the distal end of said inner tube and said outer tube.

57. A method according to claim 52 wherein an impeller coupled to said motor provides said cylindrical vortex fluid flow.

58. A method according to claim 52 wherein a said motor is coupled to a centrifugal pump which provides said cylindrical vortex fluid flow.
